(19) United States
(12) Patent Application Publication
(10) Pub. No.: US 2004/0177095 A1
(43) Pub. Date: Sep. 9, 2004

(54) Method of placing temporary workers for employment with an employer

(76) Inventor: Jeffrey M. West, Fredericksburg, TX (US)

Correspondence Address: POTTER ANDERSON & CORROON LLP, ATTN: KATHLEEN W. GEIGER, ESQ., P.O. BOX 951, WILMINGTON, DE, 19899-0951, US

(21) Appl. No.: 10/793,321

(22) Filed: Mar. 4, 2004

Related U.S. Application Data
(60) Provisional application No. 60/452,378, filed on Mar. 6, 2003.

(51) Int. Cl. G06F 17/00

(52) U.S. Cl. 707/104.1

(57) ABSTRACT

The invention relates to a method for placing temporary workers for employment with an employer. The method includes the steps of collecting information from an employer and storing this information in a first database. Then, the method calculates the earliest date when the employer can apply for visas for the temporary workers. Based on information in the first database, the method creates a time-line for the temporary workers' visa application status and employment status. Comparing the first database with a second database comprising descriptions of temporary workers identifies acceptable temporary workers. The employer is aided in the process of acquiring visas for the temporary workers. When the visas are approved, the employer is supplied with the temporary workers. The invention also relates to a nonimmigrant worker database comprising personal information and worker status of temporary workers. The nonimmigrant worker database can further comprise data about order status of employers.

### CROSS-REFERENCE TO RELATED APPLICATION

This application claims the benefit of U.S. Provisional Application No. 60/452,378 filed in the USPTO on Mar. 6, 2003, which is hereby incorporated by reference.

### FIELD THE INVENTION

The present invention relates to a method that enables employers to employ and acquire the services of temporary workers without the need of a professional service or an attorney.

### BACKGROUND

Even in difficult economic times, employers have problems filling employment needs for seasonal or temporary work. Employers often result to using illegal immigrant workers to fill these positions. The federal government, however, has created numerous options for employers seeking to hire legal, foreign workers to fill vacant temporary positions. The application process for acquiring the necessary visas for these foreign workers is an expensive and complex process at best, generally requiring the assistance of an immigration attorney or a professional immigration service to insure that the employer is following correct application procedure. Utilizing the services of an attorney or professional service, however, significantly increases the cost of acquiring visas for the foreign temporary workers. The price alone is enough to prevent many small businesses from legally acquiring the services of temporary foreign workers. Additionally, temporary foreign workers have limited, if any, access to immigration attorneys, especially attorneys located in the United States.

Employers that use immigration attorneys or professional services must still identify foreign workers that meet the requirements of the applicable visa. Unless the employer has contacts in the foreign country, the employer must hire a professional staffing service that has access to foreign workers that meet the employer's job requirements. Additionally, the foreign workers must meet the aforementioned requirements of the visa being sought by the employer.

Nonimmigrant visas for seasonal and/or temporary workers such as, for example, visas in the H-2 category, i.e., H-2A and H-2B visas, are available to temporary workers who have the sponsorship of an American employer. H-2 visas are granted only if the employer can demonstrate that there are no unemployed American workers available to fill the employer's needs. Additionally, any hiring of nonimmigrant temporary workers cannot adversely affect the wages and working conditions of similarly employed American workers. Acquisition of H-2 visas also requires the fulfillment of a double temporariness requirement: the foreign worker must be entering the United States temporarily in order to fill a temporary position with an employer. The temporary position must be a one-time occurrence, a seasonal need, a peakload need, or an intermittent need. The employer also has to pay the temporary worker the prevailing wage of an American worker in the same position, as modified by the local cost of living.

Timing on all filings is critical; if the employer misses filing dates or files too early, the entire application may be rejected. The term of an approved H-2 visa is one year with up to two one-year extensions available. Currently, up to 66,000H-2 visas may be granted each year, but, because of the difficulty in fulfilling the requirements, the limit has never been reached.

Analysis of these H-2 requirements occurs through a process known as labor certification. The first step in the labor certification process is to file an application with the employer's State Employment Security Agency (“SESA”). If the job requirements listed on the application are not too restrictive, the employer is then given permission to conduct a recruitment period. During recruitment, the employer must consider all qualified American applicants to the available job and can only reject applicants for lawful, job-related reasons. If the employer is unable to find American workers to fill the available positions, the employer then files a recruitment report with the Department of Labor (“DOL”) indicating the results of all interviews. The DOL then grants labor certification if the employer meets all of the requirements of the H-2 visa and has conducted a valid recruitment.

The next step involves filing the actual visa application with the United States Citizenship and Immigration Services (“USCIS”). The employer may file the visa application with the USCIS regardless of the results of the labor certification, but, in practice, the USCIS gives wide deference to the final judgment of the DOL. Thus, the USCIS is highly unlikely to approve visas where the labor certification was rejected by the DOL.

At this point, the employer must identify actual foreign workers seeking the benefit of an H-2 visa. The employer may specify multiple preferred workers on a single application form. Also, the employer may optionally specify additional workers that will be used as substitutes should any of the preferred workers be unavailable. Where specified, these substitute workers must meet the same requirements as the preferred workers. As mentioned above, approval of the H-2 visas are highly dependent on the results of the labor certification.

Finally, the temporary worker must gain approval from both a U.S. Consulate located in the temporary worker's home country and the USCIS port-of-entry/border patrol before the temporary worker will be allowed into the United States.

The Internet has become a common tool for employers and workers seeking immigration assistance. Applicant's prior website, Guest Workers International (“GWI”), is a service that provides temporary seasonal workers, with the occupations limited to the green industry, the construction industry, and the hospitality industry. The actual GWI service is not interactive as the employer can only perform a feasibility calculation and request further information. Additionally, based on the fees and procedures listed on the GWI website, the GWI service completes all forms for the employer. The GWI service does not, however, automatically calculate when an employer can file for a visa and does not create a time-line indicating the status of the employer's application.

Other websites exist in the prior art that attempt to assist employers in acquiring visas for temporary workers. These services do not have, however, a database of temporary workers. They also do not allow employers to search the DOL's Occupational Employment Survey for occupation descriptions or to calculate an actual rate of pay offered. Some sites do provide a method for tracking cases on-line. Forms are prepared and completed by the websites' attorneys, except in limited circumstances where very basic do-it-yourself form completion services exist.

Meltzer et al. (U.S. Pat. No. 6,366,925) disclose a web-based legal service system preferably directed to processing immigration and/or naturalization applications. As legal services are involved, clients are required to pay a retainer to the website's attorneys. After payment of retainer, clients can utilize a questionnaire interface to input the data required for a visa application form. The website's attorneys then use the information to acquire a visa for the client. The legal service system further comprises a database that contains information related to the client's legal service matters. The client can access part of this database in order to obtain updates on account status, responses to previously submitted questions, and account balance.

Additional websites function as job placement sites. Generally, these websites work as middlemen for placing workers with employers. Candidates post resumes on the site, while employers post job openings. The sites then refer the candidates to the employers if the candidates meet the employers' qualifications. Candidates from overseas must pay for their own visas in most cases. These websites, however, do not perform seasonal and/or temporary worker visa services.

Other websites permit foreign workers to register on-line for placement with employers that search the site. Employers select workers from a list of candidates. The sites negotiate with employers to cover the costs of all legal services, but do not assist an employer in obtaining visas for the candidates. Instead, the service or the employer obtains an outside immigration attorney to handle the visa application. Additionally, workers cannot be placed with the employer for at least 12 months after the employment offer has been accepted.

### SUMMARY OF THE INVENTION

Applicant provides a method for an employer to easily and conveniently complete the application process for seasonal and/or temporary worker visas, preferably visas in the H-2 category, and even more preferably in the H-2B category. Furthermore, the method supplies the employer with the temporary workers that match the employer's needs.

An embodiment of the invention provides a method for placing temporary workers for employment with an employer. The method includes the steps of collecting information from an employer and storing this information in a first database. Then, the method calculates the earliest date when the employer can apply for visas for the temporary workers. Based on information in the first database, the method creates a time-line for the temporary workers' visa application status and employment status. Comparing the first database with a second database comprising descriptions of temporary workers identifies acceptable temporary workers. The employer is aided in the process of acquiring visas for the temporary workers. When the visas are approved, the employer is supplied with the temporary workers.

The invention also provides a method for facilitating the recruitment of temporary workers. The method includes the steps of compiling a database of nonimmigrant workers. The method determines acceptable nonimmigrant workers by comparing the database to information collected from an employer. The employer is then aided in acquiring visas for the acceptable nonimmigrant workers. When the visas are approved, the employer is supplied with the acceptable nonimmigrant workers.

In a further embodiment, the invention provides for a nonimmigrant worker database stored on a computer-readable medium comprising data about the personal information of a plurality of temporary workers and data about the worker status of said plurality of temporary workers. The nonimmigrant worker database can further comprise data about the order status of employers.

### BRIEF DESCRIPTION OF THE DRAWINGS

For a more complete understanding of the present invention and for further advantages thereof, reference is now made to the following Detailed Description taken in conjunction with the accompanying Drawings in which:

FIG. 1 shows a flowchart of the initial information requests necessary for the creation of a time-line.

FIG. 2A shows a flowchart of the information requests necessary for the recruitment agency and the determination of job title and prevailing wage.

FIG. 2B shows the continuation of the flowchart in FIG. 2A indicating the information requests necessary for the determination of actual rate of pay and number of requested temporary workers.

FIG. 2C shows the continuation of the flowchart in FIG. 2B indicating the steps necessary for completion of applicable forms and acquisition of temporary workers.

### DETAILED DESCRIPTION OF THE PREFERRED EMBODIMENT

Applicant has developed a method in which employers are able to file for seasonal and/or temporary worker visas, preferably visas in the H-2 category, and even more preferably in the H-2B category, without the aid of a professional service or attorney. In the preferred embodiment, the method utilizes web-based technology and an interactive server that operates as a guide and reminder to the employer from start to finish. Furthermore, the system allows for real-time updates of activity for employers and a recruitment agency.

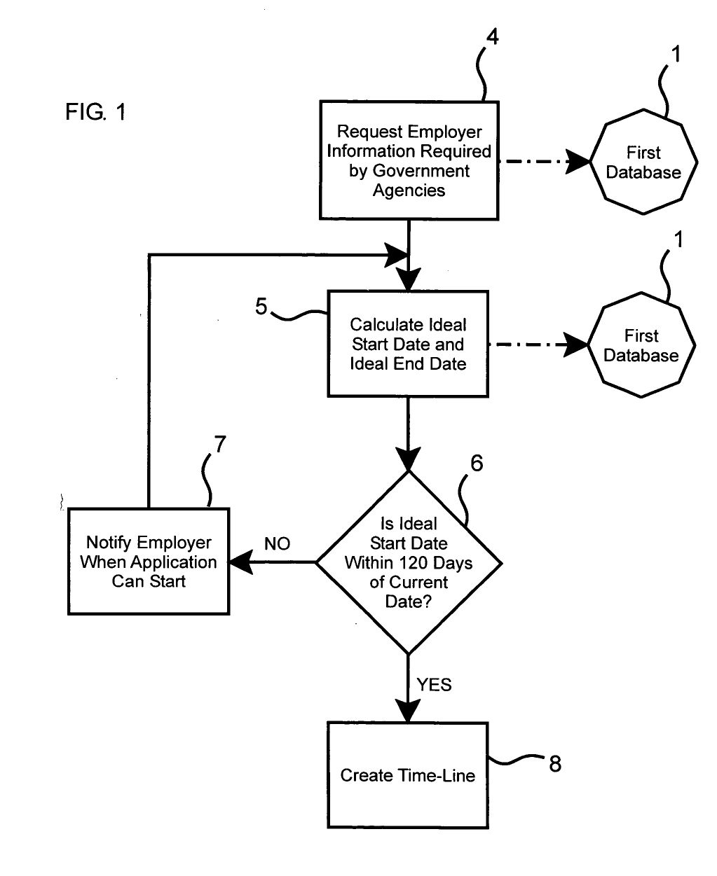

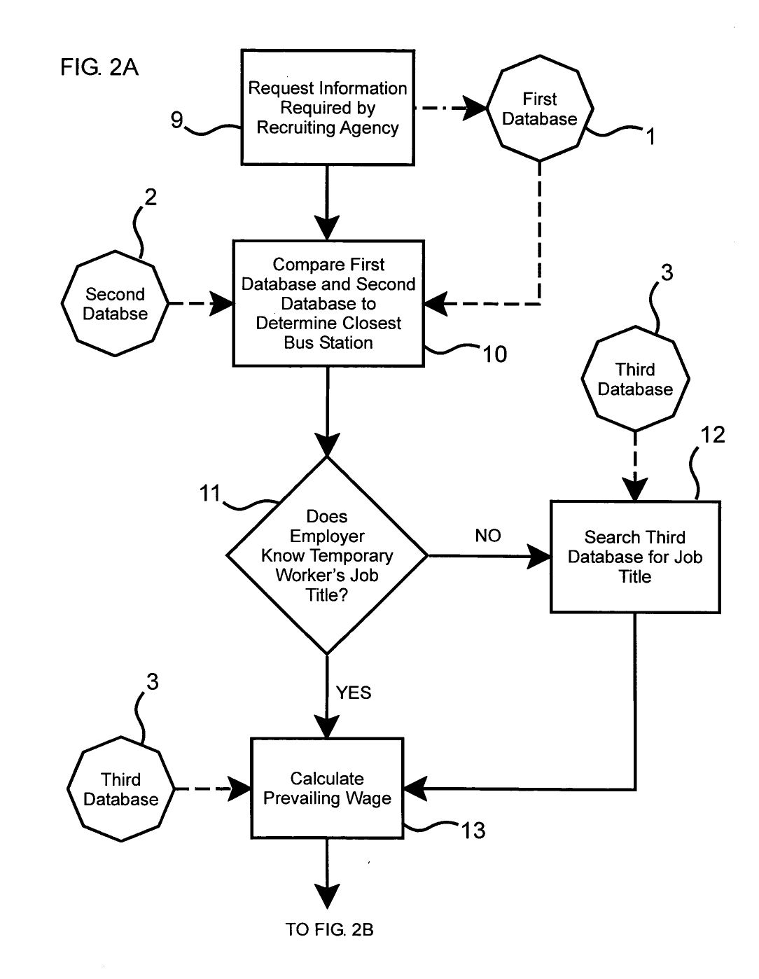

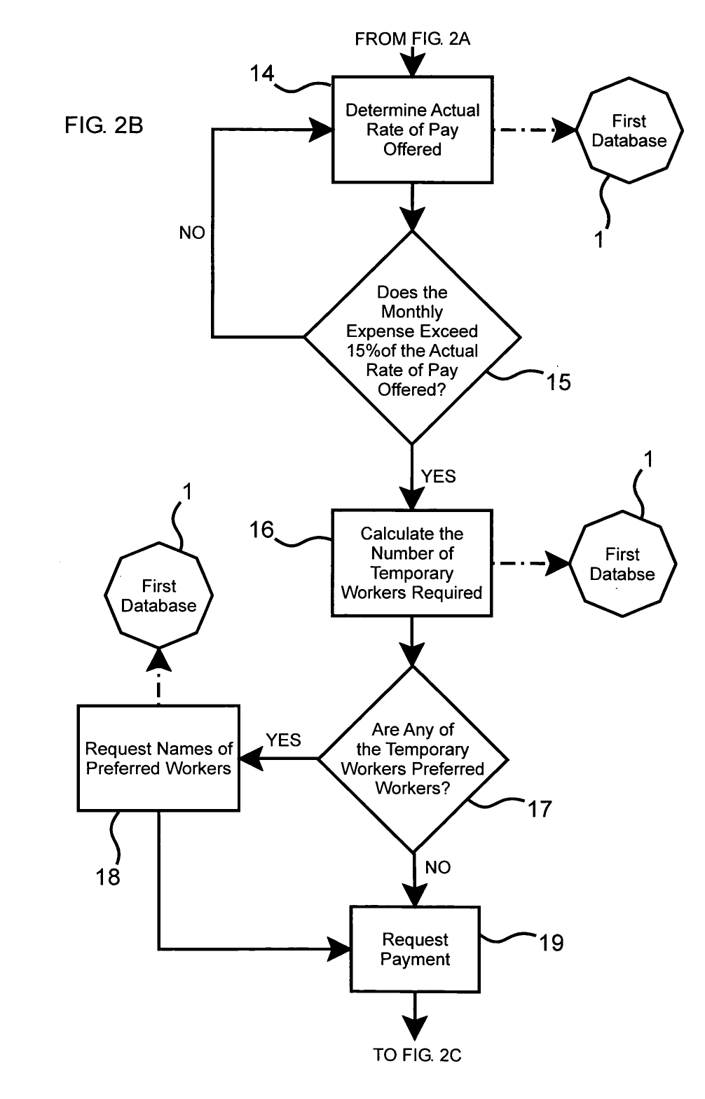

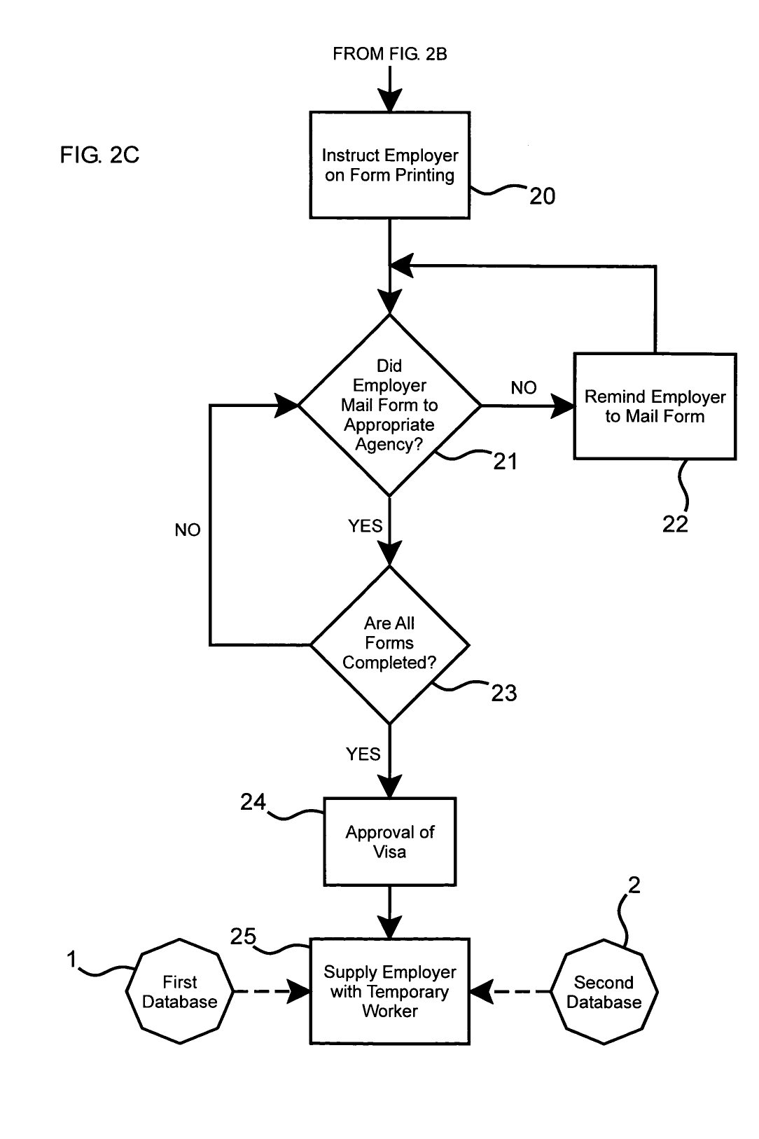

A system employing methods of the invention is shown in the flowcharts in FIGS. 1 and 2(A-C). Referring to FIG. 1, once an employer has read the instructions and has agreed to the conditions of use, the employer is prompted to provide information that is required by three agencies (4): the employer's State Employment Security Agency (“SESA”), the Department of Labor (“DOL”), and the United States Citizenship and Immigration Services (“USCIS”). The information collected from the employer is stored in a first database (1) for use at a later time.

The system also provides for a second database (2) comprising a plurality of temporary worker descriptions that is located at the recruitment agency. This second database is able to provide live updates to the employer about the status of the temporary workers. The employer is notified when a requested temporary worker checks into the recruitment agency. Once a requested temporary worker has checked into the recruitment agency, a bar code sticker is administered to the requested temporary worker's passport. For each step in the placement process, starting with the date that the temporary worker checks into the recruitment agency until the temporary worker boards transportation bound for the United States, a scanner is used to track the movement of the temporary worker's passport. This tracking information is available at all times to the employer by accessing the second database. The employer can also view specific information about each temporary worker by accessing the second database. This specific information includes the temporary worker's check-in date, the recruitment agency where the temporary worker checked in, the temporary worker's passport submission date, the Consulate's approval status, the temporary worker's visa interview date, the temporary worker's departure date, the temporary worker's transport method, and the anticipated job site arrival date. Additionally, a picture identification of the temporary worker is provided for in the second database, reducing fraud potential.

After the employer has answered the required questions, the system next determines the date the employer would like the temporary workers to arrive and begin work, as well as the ending date in which the temporary workers will depart (5). This step is a critical point in the process due to vague rules and regulations. According to DOL rules, an employer can apply no sooner than 120 days before the temporary workers are needed (6). Nor can the temporary workers stay longer than ten months at their place of employment before the temporary workers are required to return to their homeland. For example, if an employer requires a temporary worker(s) to arrive for work on Mar. 15, 2003, and the present date is Aug. 15, 2002, the system will compute that the earliest the employer can file is 120 days before Mar. 15, 2003, or Nov. 16, 2002. Likewise, if the difference between the arrival date and departure date exceeds ten months, the system will not allow the employer to apply until it has changed dates to reflect the DOL rules. If the employer is attempting to apply for a seasonal and/or temporary worker visa sooner than the 120 day period, the system will ask the employer if it would like to be reminded when it can apply (7). Ideal start date and ideal end date of employment are stored in the first database (1).

Once the arrival and departure date are accepted by the system as valid dates, the system creates a time-line of events (8) in order for the employer to understand and recognize how long each step should take as well as track progress of the application. This time-line is valuable for four major reasons: (a) if the dates do not correspond with DOL regulations, the petition will be returned, losing valuable time; (b) the time-line indicates to the employer how long each step should take and identifies when a petition is behind schedule; (c) the time-line is a useful tool for the recruitment agency and allows the recruitment agency to estimate when a petition will be authorized; and (d) if the employer falls considerably behind in the process, the system will generate an automated e-mail that provides key names, contacts, and addresses.

Referring to FIG. 2A, the next step involves acquiring all relevant information necessary to complete the required forms as well as information for the recruitment agency to identify preferred workers to be recruited and processed (9). This information is stored in the first database (1). An Internet link provides access to the second database (2) to determine the closest bus station (10). The system displays a page from the Greyhound® website where the employer can then choose the closest bus station.

The system next determines the temporary workers' prevailing wage (13). Employer information required by this step includes the employer's business address and the type of occupation in which the temporary workers will be employed. To determine the type of occupation, the employer enters a word that closely corresponds with the type of occupation in which the temporary workers will be employed (11). This word is then compared to a third database (3) comprising the DOL's Occupational Employment Survey (“OES”) (12). The employer can scroll through the database to find the correct occupation. Once the correct occupation has been selected, the job description is exported to the first database (1) and eventually is used to fill in the applicable sections of the required visa forms.

Additionally, the prevailing wage is automatically exported to the first database (1). What is unique about this method is that the prevailing wage is determined by comparing the business address of the employer with the temporary worker's job title. Furthermore, the prevailing wage accepted by the DOL can be calculated at 95% of the wage listed in the OES. The system automatically converts the calculated wage to the 95% rate and exports this value to the first database (1).

Referring to FIG. 2B, the system requires employers to offer a minimum hourly pay rate of $7.00 ($1,200 monthly) or the previously described prevailing wage, whichever is the greater amount (14). Based on the rate of pay offered, the system automatically computes the amount of overtime wage. Additionally, the cost of housing and miscellaneous expenses is required. The system does not allow monthly expenses to exceed 15% of the monthly wage of the temporary worker (15). This monthly expense cap protects the temporary worker from exploitation and increases the likelihood that the temporary worker will fulfill the contractual obligation with the employer.

The employer then inputs the number of requested temporary workers (16). If the employer requests preferred workers, i.e., specific temporary workers that the employer would like contacted, a column of blank entries are provided corresponding with the number of preferred workers requested (17, 18). Information provided here enables the recruitment agency to contact the preferred workers.

A payment step is provided (19), whereby the employer pays a per temporary worker fee for the placement of the requested temporary workers. Once the payment step has been accomplished, the employer will receive an automated e-mail detailing the transaction.

Referring to FIG. 2C, the employer is then guided to the next step that explains which forms are necessary for the temporary workers' visas (20). Information from the first database (1) is automatically entered into electronic versions of the forms. The system aids the employer in the printing process as some forms need to be printed on both sides of a sheet of paper. Each form is printed according to governmental regulations via standard Portable Document Format (“PDF”) files. The forms required are a DOL Application for Alien Employment Certification (ETA-750), a USCIS Petition for a Nonimmigrant Worker (I-129), a USCIS Request for Premium Processing (I-907), a Letter of Authorization to Consulate, a Letter for Substitution of Workers to Consulate, and a Letter Authorizing Processing of Workers to Consulate. The employer is then instructed to sign the forms and mail the forms along with any applicable fee to the appropriate government office.

One of the unique aspects of this system is that the information about the temporary workers to be exported into the forms is collected from a second database (2) at a recruitment agency, wherein the recruitment agency is preferably in Mexico. For example, if the employer is requesting four new temporary workers, the recruitment agency recruits the workers and downloads the required information of each temporary worker into the employer's application. This required information includes the temporary worker's full name, date of birth, country of birth, and passport number.

Once the employer downloads and prints the first form, which is sent to their SESA, the system sends an automated e-mail to the employer that asks the employer whether the form was completed and mailed to the correct address (21). The employer is provided with two fields, Yes or No to check off. By checking off one of the boxes and replying to the e-mail, the information is returned to the system. An automated e-mail is sent each day until the employer is able to check off the Yes box (22). Once the employer has checked the Yes box and replied to the system, the system initiates a time clock that tracks when the next step should be accomplished. The system repeats the process of guiding the employer through form printing and automated e-mail requests until all applicable forms and payments have been mailed to the correct government agencies (23). Concurrently, the time-line is updated to reflect all recent developments of the employer's order.

Upon approval by all applicable government agencies (24), temporary workers are supplied to the employer (25). Once the temporary workers have checked into the recruitment office, a bar code sticker is administered to their passports. Thus, the recruitment office can track, via bar code scanner, when the temporary workers board buses bound for the bus station nearest the employer's business address. The method calculates the location of the bus station through a comparison of the first database (1) and second database (2) as described above. Additionally, data acquired by the bar code scanner, i.e., temporary worker location, can be exported to the first database and included into the timeline. Thus, when the employer accesses the timeline, the employer can view information provided by the bar code scanner in connection with individual worker descriptions provided by the second database (2). The employer can also view photo identifications of requested temporary workers.

Applicant's invention also provides for a nonimmigrant worker database stored on a computer-readable medium comprising data about personal information and worker status of the nonimmigrant temporary workers. Upon check-in at a local recruitment agency, temporary workers give their full name, birth date, country of birth, passport number, and photo identification to the onsite recruiter. This information is inputted into the nonimmigrant worker database. Additionally, data comprising the check-in date and location of the recruitment agency is entered into the database.

In the case of nonimmigrant workers who previously have worked in the United States under a different name and/or social security number, the temporary workers can supply this information to the local recruitment agency for inputting into the nonimmigrant worker database. Providing this information in the database permits employers to search for preferred workers based on the different name and/or social security number. The database can then supply the employer with the temporary workers' accurate name and/or social security number for filing with the appropriate government agencies.

When an employer has requested temporary workers through a method of the invention, data about the employer is transferred to the nonimmigrant worker database. This data includes the name and business address of each employer requesting temporary workers. Additionally, the anticipated start date for temporary workers requested by each employer are stored in the database. The database also tracks the number of preferred and bilingual temporary workers an employer has requested.

As temporary workers are matched with employers, the database tracks the visa filing status and the results of Consulate interviews. Upon visa and Consulate interview approval, the database tracks the departure date, transportation status, and anticipated arrival date of each temporary worker.

Applicant's invention further describes a method of facilitating the acquisition of temporary workers using the aforementioned immigrant worker database. By comparing the information in the immigrant worker database to information collected from an employer, the method of the invention selects acceptable nonimmigrant workers to be placed in temporary positions with the employer. Information collected from the employer includes, but is not limited to, the employer's address, a job description, number of temporary workers needed, number of preferred workers requested, and a beginning and end date of employment.

Acceptable nonimmigrant workers have skills that apply to the employer's job description. Additionally, acceptable nonimmigrant workers are available to work during the range of dates encompassing the beginning and end date of employment as requested by the employer. Acceptable nonimmigrant workers must have a valid passport and have completed a Consulate interview.

After acceptable nonimmigrant workers have been selected, the method aids the employer in obtaining visas for the nonimmigrant workers. By aiding is meant that the employer is guided through the process of completing applicable forms and filing the applicable forms with the appropriate government agencies, preferably through the process described above.

The method also provides for a supplying step whereby the acceptable nonimmigrant workers are sent to the employer. Acceptable nonimmigrant workers are sent to the employer by any available transportation method, preferably by bus. When transportation is by bus, the acceptable nonimmigrant workers' destination is calculated to be the nearest bus station to the employer's address.

From the above discussion, one skilled in the art can ascertain the essential characteristics of this invention, and without departing from the spirit and scope thereof, can make various changes and modifications of the invention to adapt it to various usage and conditions.

We claim:

1. A method of placing at least one temporary worker for employment with an employer which comprises:
collecting information from an employer,
storing said information in a first database,
calculating an earliest date when said employer can apply for a visa of an at least one temporary worker,
creating a time-line for a visa application status and an employment status of said at least one temporary worker,
providing a second database comprising a plurality of temporary worker descriptions,
comparing said first database with said second database,
aiding said employer in obtaining said visa for said at least one temporary worker, and
supplying said employer with said at least one temporary worker upon approval of said visa.

2. The method of claim 1 wherein said information comprises data required for the acquisition of said visa.

3. The method of claim 1 wherein said information comprises an ideal start date of employment of said at least one temporary worker and an ideal end date of employment of said at least one temporary worker.

4. The method of claim 3 wherein said earliest date is about 120 days prior to said ideal start date of employment.

5. The method of claim 3 wherein said ideal end date of employment is no greater than ten months after said ideal start date of employment.

6. The method of claim 1 wherein said aiding step comprises the step of notifying said employer when said employer can apply for said visa.

7. The method of claim 6 wherein said employer is notified by e-mail.

8. The method of claim 1 wherein said aiding step comprises the step of notifying said employer when said employer is behind schedule.

9. The method of claim 8 wherein said employer is notified by e-mail.

10. The method of claim 1 wherein said information comprises a business address of said employer.

11. The method of claim 10 wherein said business address is used to determine a closest bus station to said business address.

12. The method of claim 1 further comprising the step of calculating a prevailing wage for said at least one temporary worker.

13. The method of claim 12 wherein said information comprises a business address of said employer.

14. The method of claim 13 wherein said prevailing wage is a calculation determined by comparing said information to a third database comprising an Occupational Employment Survey.

15. The method of claim 14 wherein said prevailing wage is 95% of said calculation.

16. The method of claim 14 wherein said employer searches said third database for a job title and a job description.

17. The method of claim 1 comprising the further step of calculating a monthly expense of said at least one temporary worker.

18. The method of claim 17 wherein said monthly expense comprises transportation costs, housing costs, utility costs, and employment costs.

19. The method of claim 18 wherein said employment costs comprises clothing and tools.

20. The method of claim 17 wherein said monthly expense does not exceed 15% of an actual rate of pay offered by said employer.

21. The method of claim 20 wherein said actual rate of pay offered is a dollar value of at least 1,200 per month.

22. The method of claim 1 wherein said at least one temporary worker is preferentially requested by said employer.

23. The method of claim 1 further comprising the step of guiding said employer through the procedure of printing an applicable form.

24. The method of claim 23 wherein said applicable form is an Application for Alien Employment Certification.

25. The method of claim 23 wherein said applicable form is a Petition for a Nonimmigrant Worker.

26. The method of claim 23 wherein said applicable form is a Request for Premium Processing Service.

27. The method of claim 23 wherein said applicable form is a Letter of Authorization to Consulate.

28. The method of claim 23 wherein said applicable form is a Letter for Substitution of Workers to Consulate.

29. The method of claim 23 wherein said applicable form is a Letter Authorizing the Processing of Workers to Consulate.

30. The method of claim 1 further comprising the step of directing said employer to mail an applicable form along with correct fees to an appropriate government agency.

31. The method of claim 30 wherein said appropriate government agency is a State Employment Security Agency.

32. The method of claim 30 wherein said appropriate government agency is the Department of Labor.

33. The method of claim 30 wherein said appropriate government agency is the United States Citizenship and Immigration Services.

34. The method of claim 30 wherein said appropriate government agency is a United States Consulate.

35. The method of claim 34 wherein said United States Consulate is located in Mexico.

36. The method of claim 1 wherein said supplying step comprises the step of recruiting said at least one temporary worker.

37. The method of claim 36 wherein said at least one temporary worker is a nonimmigrant alien.

38. The method of claim 37 wherein said nonimmigrant alien is a Mexican.

39. The method of claim 1 wherein said second database is located at a recruitment agency.

40. The method of claim 39 wherein said recruitment agency is located in a city in Mexico.

41. A method of facilitating the acquisition of at least one temporary worker which comprises:
compiling a database of a plurality of nonimmigrant workers
collecting information from a requesting employer,
comparing said information with said database,
selecting an at least one acceptable nonimmigrant worker from said database,
aiding said employer in obtaining a visa for said at least one acceptable nonimmigrant worker, and
supplying said employer with said at least one acceptable nonimmigrant worker upon approval of said visa.

42. The method of claim 41 wherein said database is located at a recruitment agency.

43. The method of claim 42 wherein said recruitment agency is located in Mexico.

44. The method of claim 41 wherein said nonimmigrant workers are Mexican.

45. The method of claim 41 wherein said information comprises data required for the acquisition of said visa.

46. A nonimmigrant worker database stored on a computer-readable medium comprising:
data about personal information of a plurality of temporary workers; and
data about worker status of said plurality of temporary workers.

47. The nonimmigrant worker database of claim 46 wherein said data about personal information comprises a full name of each temporary worker.

48. The nonimmigrant worker database of claim 47 wherein said data about personal information further comprises a birth date of each temporary worker.

49. The nonimmigrant worker database of claim 47 wherein said data about personal information further comprises a passport number of each temporary worker.

50. The nonimmigrant worker database of claim 47 wherein said data about personal information further comprises a photo identification of each temporary worker.

51. The nonimmigrant worker database of claim 47 wherein said data about personal information further comprises a country of birth of each temporary worker.

52. The nonimmigrant worker database of claim 46 wherein said data about worker status comprises a check-in date of each temporary worker.

53. The nonimmigrant worker database of claim 52 wherein said data about worker status further comprises a location of a recruitment agency.

54. The nonimmigrant worker database of claim 53 wherein said location is a city in Mexico.

55. The nonimmigrant worker database of claim 46 wherein said data about worker status comprises a departure date of an at least one requested temporary worker.

56. The nonimmigrant worker database of claim 46 wherein said data about worker status comprises an anticipated arrival date of an at least one requested temporary worker.

57. The nonimmigrant worker database of claim 46 wherein said data about worker status comprises a result of Consulate interview of an at least one requested temporary worker.

58. The nonimmigrant worker database of claim 46 wherein said data about worker status comprises a transportation status of an at least one requested temporary worker.

59. The nonimmigrant worker database of claim 46 further comprising data about order status of an at least one employer.

60. The nonimmigrant worker database of claim 59 wherein said data about order status comprises a name of said at least one employer.

61. The nonimmigrant worker database of claim 60 wherein said data about order status further comprises a business address of said at least one employer.

62. The nonimmigrant worker database of claim 60 wherein said data about order status further comprises an anticipated start date of an at least one requested temporary worker.

63. The nonimmigrant worker database of claim 60 wherein said data about order status further comprises a filing date of a visa for an at least one requested temporary worker.

64. The nonimmigrant worker database of claim 60 wherein said data about order status further comprises a number representing a total amount of temporary workers requested for employment by said at least one employer.

65. The nonimmigrant worker database of claim 60 wherein said data about order status further comprises a number representing a total amount of preferred temporary workers requested for employment by said at least one employer.

66. The nonimmigrant worker database of claim 60 wherein said data about order status further comprises a number representing a total amount of bilingual temporary workers requested for employment by said at least one employer.
